(19) United States
(12) Patent Application Publication
(10) Pub. No.: US 2011/0292834 A1
(43) Pub. Date: Dec. 1, 2011

(54) Maintaining Time Series Models for Information Technology System Parameters

(75) Inventors: Dakshi Agrawal, Monsey, NY (US); Matthew E. Duggan, Chertsey (GB); Kang-Won Lee, Nanuet, NY (US); Mudhakar Srivatsa, White Plains, NY (US); Kristian J. Stewart, Hampton (GB); Petros Zerfos, (US)

(73) Assignee: International Business Machines Corporation, Armonk, NY (US)

(21) Appl. No.: 12/789,058

(22) Filed: May 27, 2010

(51) Int. Cl. H04L 12/28

(52) U.S. Cl. 370/255

(57) ABSTRACT

A network-centric modeling mechanism is provided for updating network models in order to mitigate network issues. The network-centric modeling mechanism determines for each component in a plurality of components whether a system parameter in a set of parameters particular to the component has deviated from a predicted system parameter value in a set of predicted system parameter values past a predetermined threshold. Responsive to the system parameter deviating from the predicted system parameter value past the predetermined threshold, the network-centric modeling mechanism generates an event stream indicating a sufficient deviation. The network-centric modeling mechanism determines whether the event stream matches a previous pattern. Responsive to identifying the previous pattern that matches the event stream, the network-centric modeling mechanism preemptively mitigates any related issues in the component or in a related component in the plurality of components using topology-aware indices associated with the previous pattern.

### BACKGROUND

The present application relates generally to an improved data processing apparatus and method and more specifically to mechanisms for maintaining time series models for information technology parameters.

In order to manage large scale information technology (IT) systems, a typical systems-management software monitors system parameters periodically. It is not uncommon for a systems-management software to monitor millions of such parameters from a distributed IT system and store the periodically obtained values of system parameters in a database. The collected data is further analyzed to efficiently manage the IT system. Many systems-management software systems also provide prediction capabilities wherein based on the past values, a “model” of the monitored parameter is computed and a future value of the parameter is estimated. If the actual value of the parameter in future turns out to be significantly different from its estimated value, then it may indicate a deviation from the normal and require further investigation.

Typically, parameters of a system, such as traffic in a network link, drift over time which means that the model of a parameter may change with time. Current management software typically discounts past values, such as using an exponentially or linearly weighted curve, and keeps the model updated continuously. Since updating the model for a parameter may not be practical each time a new value for the parameter is obtained, the model may only be updated after several new parameter values have been obtained or after a certain time interval has passed. To conserve computing resources that are used to update the model, a system may use various criteria to select the update frequency of a parameter model.

Known systems use a criteria that consists of user-specified rules: (a) a class of parameters may have its model updated frequently; (b) if the difference between predicted and actual values exceeds a threshold, the model may be updated, etc. The key shortcoming of these criteria is that either they require extensive knowledge of system parameters or the knowledge of how quickly the models are likely to change, which may be unknown and require educated guesses. When these rules are used, by the time an obsolete model is detected, it may already be too late in the sense that the obsolete model may have already caused a false alarm. Dealing with such false alarms is one of the major concerns of the systems-management software.

### SUMMARY

In one illustrative embodiment, a method, in a data processing system, is provided for updating network models in order to mitigate network issues. The illustrative embodiment determines for each component in a plurality of components in the data processing system whether a system parameter in a set of parameters particular to the component has deviated from a predicted system parameter value in a set of predicted system parameter values past a predetermined threshold. The illustrative embodiment generates an event stream indicating a sufficient deviation in response to the system parameter deviating from the predicted system parameter value past the predetermined threshold. The illustrative embodiment determines whether the event stream matches a previous pattern in a plurality of stored patterns. The illustrative embodiment preemptively mitigates any related issues in the component or in a related component in the plurality of components using topology-aware indices associated with the previous pattern in response to identifying the previous pattern that matches the event stream.

In other illustrative embodiments, a computer program product comprising a computer useable or readable medium having a computer readable program is provided. The computer readable program, when executed on a computing device, causes the computing device to perform various ones, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a pictorial representation of an example distributed data processing system in which aspects of the illustrative embodiments may be implemented;

FIG. 2 depicts a block, diagram of an example data processing system in which aspects of the illustrative embodiments may be implemented;

FIG. 3 is an example block diagram illustrating the main operational components and their interactions in accordance with one illustrative embodiment; and

FIG. 4 provides a flowchart outlining example operations of a network centric, modeling mechanism in accordance with an illustrative embodiment.

### DETAILED DESCRIPTION

Again, known system management software typically monitors many system parameters and creates a model of the system parameter's behavior that may drift over time requiring model updates. The model update of a system parameter is an expensive operation and a system may use various criteria to select the update frequency of a parameter model. The illustrative embodiments provide a network-centric mechanism for updating models leading to better predictive capabilities and less false alarms. The mechanism of the illustrative embodiments trigger an update of the models in a cascading manner where an update of one parameter model may trigger updates of other model parameters that are related to each other by a “network pattern.” The mechanism “learns” of and identifies these network patterns and how the network patterns may be used to schedule model updates.

The key idea of the illustrative embodiments is to consider relationships between various system parameters and create a two layer network where a lower layer or physical network represents physical and logical entities and their relationship (e.g., downstream, upstream, contained, container, tunnel, etc.) and a higher layer of information network represents parameters and their known relationship. The relationships in the information network are derived from the underlying physical network as well as known correlations between different parameters. The relationships in the information network are used to trigger the model updates, such that an update of one parameter model triggers updates of other models parameters which are related to the triggering parameter by a certain relationship. In this way, portions of the network that are potentially more dynamic are updated more frequently than those that are relatively stable.

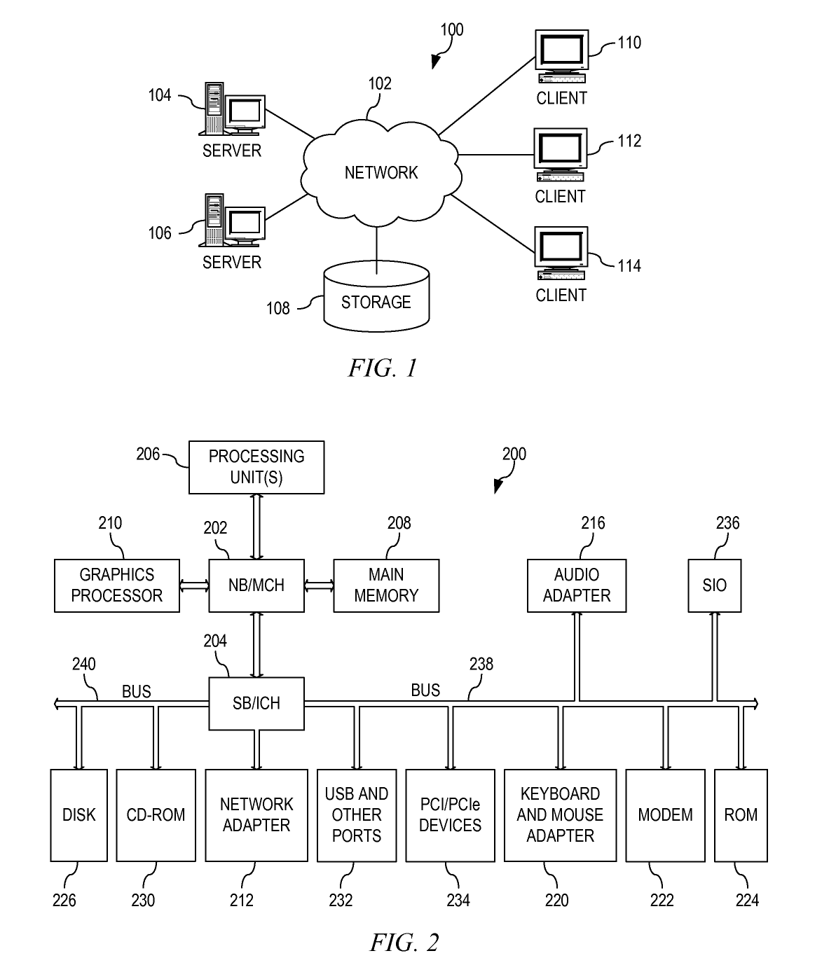

Thus, the illustrative embodiments may be utilized in many different types of data processing environments including a distributed data processing environment, a single data processing device, or the like. In order to provide a context for the description of the specific elements and functionality of the illustrative embodiments, FIGS. 1 and 2 are provided hereafter as example environments in which aspects of the illustrative embodiments may be implemented. While the description following FIGS. 1 and 2 will focus primarily on a single data processing device implementation of maintaining time series models for information technology parameters, this is only an example and is not intended to state or imply any limitation with regard to the features of the present invention. To the contrary, the illustrative embodiments are intended to include distributed data processing environments and embodiments in which information technology parameters are maintained for time series models.

With reference now to the figures and in particular with reference to FIGS. 1-2, example diagrams of data processing environments are provided in which illustrative embodiments of the present invention may be implemented, it should be appreciated that FIGS. 1-2 are only examples and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

With reference now to FIG. 2, a block diagram of an example data processing system is shown in which aspects of the illustrative embodiments may be implemented. Data processing system 200 is an example of a computer, such as client 110 in FIG. 1. in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example. Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM eServer™ System p® computer system, running the Advanced Interactive Executive (AIX®) operating system or the LINUX operating system (eServer, System p, and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device which is configured with flash memory to provide non-volatile memory for storing operating system files and/or user-generated data, for example. Essentially, data processing system 200 may be any known or later developed data processing system without architectural limitation.

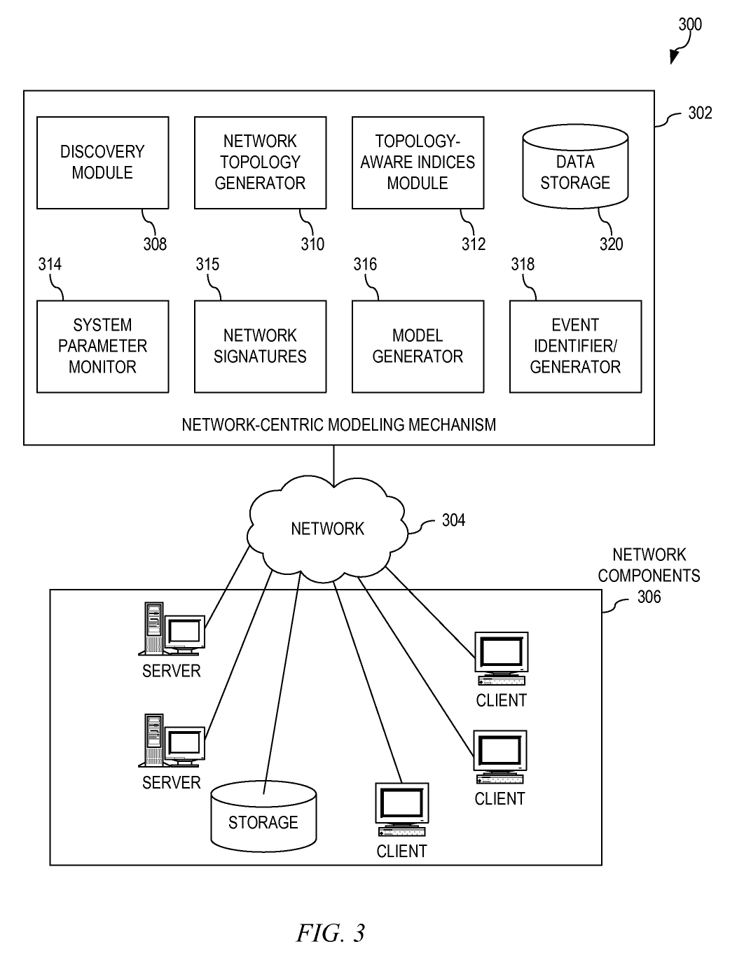

FIG. 3 is an example block diagram illustrating the main operational components and their interactions in accordance with one illustrative embodiment. The elements shown in FIG. 3 may be implemented in hardware, software, or any combination of hardware and software. In one illustrative embodiment, the elements of FIG. 3 are implemented as software executing on one or more processors of one or more data processing devices or systems.

As shown in FIG. 3, the operational components of data processing system 300 comprises network-centric modeling mechanism 302, network 304, and network components 306. Network-centric modeling mechanism. 302 may be instantiated as a standalone device, component, or entity data processing system 300 or on an existing device, component, or entity in data processing system 300. Network-centric modeling mechanism 302 may further comprise discovery module 308, network topology generator 310, topology-aware indices module 312, system parameter monitor 314, network signatures 315, model generator 316, and event identifier/generator 318. Upon initialization of network-centric modeling mechanism 302, discovery module 308 performs a discovery of each component within data processing system 300 indirectly or directly coupled to network-centric modeling mechanism 302. Upon discovery of the components within data processing system 300, network topology generator 310 generates a physical network topology of the components within data processing system 300. Using the physical network topology, network topology generator 310 generates an information network topology by superimposing a set of network relationships on to the physical network topology. A network relationship annotates a logical pair-wise relations edge between two network entities with a relationship. Examples of network relationships may include self-containment, neighbors (e.g., neighbors in layer 2 topology, neighbors in layer 3 Open Shortest Path First (OSPF) topology, Border Gateway Protocol (BGP) peers, or the like), tunnels (e.g. Multiprotocol Label Switching (MPLS) to create Virtual Private Networks (VPNs) (MPLSNPN) tunnels), downstream, upstream, or the like. Network relationships may be specified by a network administrator, system user, or the like, or may be automatically extracted Service Level Agreements, policies, rules, or the like.

By superimposing the set of network relationships onto the physical network topology, network topology generator 310 generates an information network topology that indicates how each component is performing with relation to each network relationship. Topology-aware indices module 312 then indexes the information network topology to support scalable query answering (e.g., finding all network entities that are downstream to an entity a with respect to monitor in). “Index” by definition is a system that makes finding information easier. Topological aware indices are a special class of “indices” that allows for efficiently finding of R(n) and R⁻¹(n) for some network relationship R and a network entity n. With the set of topology-aware indices established, system parameter monitor 314 monitors each of a set of system parameters particular to each component in data processing system 300. The set of system parameters may be a size of a buffer, utilization of a processor, amount of traffic in a network link, or the like. Since networks, such as data processing system 300, may generate massive monitoring data, system parameter monitor 314 monitors the set of network relationships using both spatial and temporal observations and stores the monitored data in data storage 320.

Network signatures 315 encode dependency between network relationships across one or more network entities. In general, a network signature in network signatures 315 may be of the form: networkEventType→(networkRelation, timeWindowDistribution, networkEventType, confidence) For example, highCPUUtil→(Layer 3 neighbor, 0-10 seconds, highBufferUtil, 0.9). In simple words, high CPU utilization on a network entity n, may result in high buffer utilization on a network entity m that is a layer 3 neighbor of entity n within 0-10 seconds (after highCPUUtil) with a confidence level of 0.9. Network signatures 315 may be automatically mined from historical datasets or supplied as a configuration input from a network administrator, system user, or the like. Model generator 316 then uses the monitored data stored in data storage 320 to prepare network relationship models.

Event identifier/generator 318 uses network signatures 315 to predict changes in system parameters in one network entity, based on changes in system parameters observed in a “related” network entity. For each component in data processing system 300, event identifier/generator 318 determines for each parameter in a set of system parameters whether the parameter has deviated from a predicted system parameter value past a predetermined threshold. If the parameter for that component indicates that the system parameter has deviated past the predetermined threshold of the predicted system parameter value, event identifier/generator 318 generates an event stream indicating a sufficient deviation. Event identifier/generator 318 then performs a predictive matching using network patterns stored in data storage 320 and the topology-aware indices. The network patterns may be patterns indicating, for example, that high processor utilization in one node may cause high processor utilization in a downstream node at some time t after the initial high utilization is detected. If event identifier/generator 318 identifies such a network pattern, event identifier/generator 318 uses the topology-aware indices to preemptively mitigate the exemplary high processor utilization in the downstream node by, for example, sending requests to the downstream node to bring additional processors online.

If event identifier/generator 318 fails to identify such a network pattern, then event identifier/generator 318 may identify what the effects of the event stream indicating a sufficient deviation has on other components in data processing system 300. If the event stream indicating a sufficient deviation causes other events sufficient deviations, then event identifier/generator 318 may generate a new network pattern of events and store the network pattern in data storage 320. Thus, the new network pattern may be used in future cases where the high processor utilization in one node causes high processor utilization in a downstream node. Additionally, event identifier/generator 318 may also use the monitored data to update network signatures 315 that capture inter-dependencies system parameters across one or more entities in data processing system 300.

Thus, the illustrative embodiments provide a network-centric mechanism for updating models leading to better predictive capabilities and less false alarms. The mechanism of the illustrative embodiments trigger an update of the models in a cascading manner where an update of one parameter model may trigger updates of other model parameters that are related to each other by a “network pattern.” The mechanism “learns” of identifies these network patterns and how the network patterns may be used to schedule model, updates.

As will be appreciated by one skilled in the art, the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in any one or more computer readable medium(s) having computer usable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, device, or any suitable combination of the foregoing. More specific examples (a non-exhaustive list) of the computer readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Computer code embodied on a computer readable medium may be transmitted using any appropriate medium, including but not limited to wireless, wireline, optical fiber cable, radio frequency (RF), etc., or any suitable combination thereof.

Computer program code for carrying out operations for aspects of the present invention may be written in any combination of one or more programming languages, including an object oriented programming language such as Java™, Smalltalk™, C++, or the like, and conventional procedural programming languages, such as the “C” programming language or similar programming languages. The program code may execute entirety on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions, These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified in the flowchart and/or block diagram block or blocks.

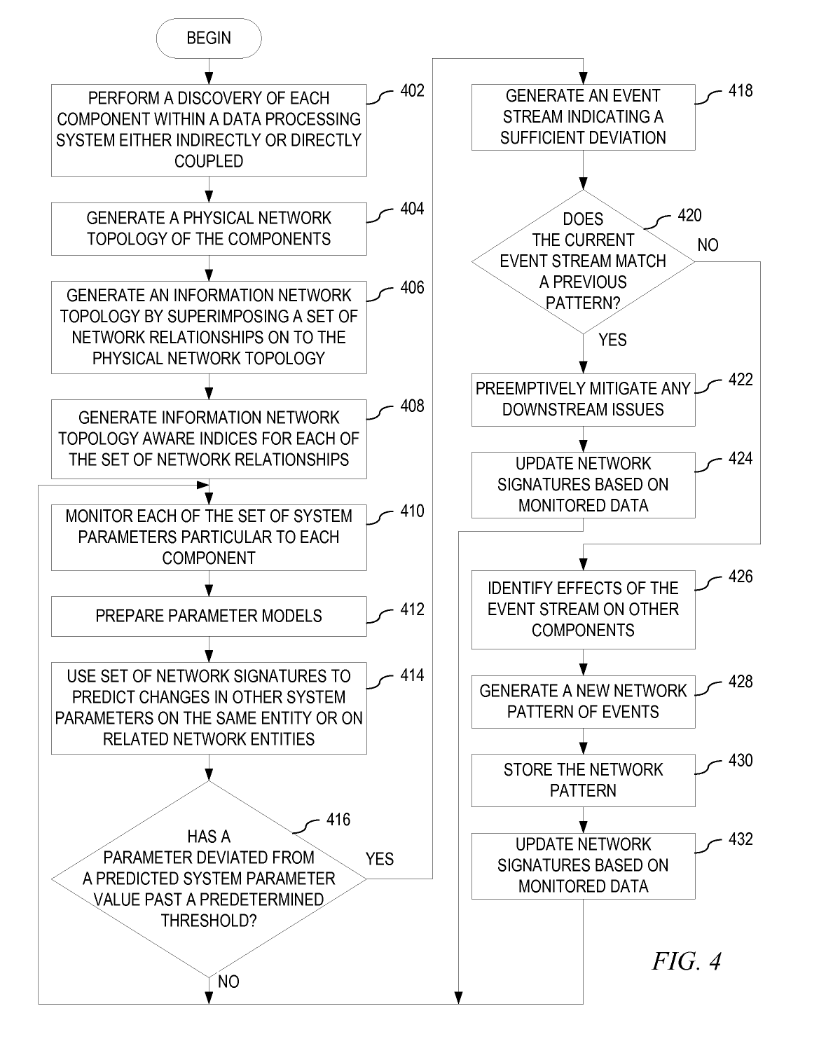

Referring now to FIG. 4, this figure provides a flowchart outlining example operations of a network-centric modeling mechanism in accordance with an illustrative embodiment. As the operation begins, a discovery module within the network-centric modeling mechanism performs a discovery of each component within a data processing system either indirectly or directly coupled to the network-centric modeling mechanism (step 402). Upon discovery of the components within the data processing system, a network topology generator within the network-centric modeling mechanism generates a physical network topology of the components within the data processing system (step 404). The network topology generator then generates an information network topology by superimposing a set of network relationships on to the physical network topology (step 406). By superimposing the set of network relationships onto the physical network topology, the network topology generator generates an information network topology that indicates how each component is performing with relation to each network relationship.

An aware indices module within the network-centric modeling mechanism then uses the information network topology to generate information network topology-aware indices for each of the set of network relationships thereby generating a set of information network topology-aware indices (step 408). A system parameter monitor uses the set of information network topology-aware indices to monitor each of a set of system parameters particular to each component in the data processing system (step 410). A model generator within the network-centric modeling mechanism then uses the monitored data to prepare parameter models (step 412).

On observing deviations in one or more system parameters on a network entity, the event identifier/generator uses a set of network signatures to predict changes in other system parameters on the same entity or to predict changes in system parameters on related network entities (step 414). For each component in the data processing system, the event identifier/generator determines for each parameter in a set of system parameters whether the parameter has deviated from a predicted system parameter value past a predetermined threshold (step 416). If at step 416 the system parameter for that component indicates that the system parameter fails to have deviated past the predetermined threshold of the predicted system parameter value, then the operation returns to step 410.

If at step 416 the system parameter for that component indicates that the system parameter has deviated past the predetermined threshold of the predicted system parameter value, the event identifier/generator generates an event stream indicating a sufficient deviation (step 418). The event identifier/generator then performs a predictive matching using stored network patterns and the information network topology-aware indices to determine whether the current event stream matches a previous pattern (step 420). If at step 420 the event identifier/generator identifies such a network pattern, the event identifier/generator uses the information network topology-aware indices to preemptively mitigate any downstream issues that may occur according to the matched pattern (step 422). Optionally, the event identifier/generator updates the network signatures based on the monitored data (step 424), with the operation returning to step 410 thereafter.

If at step 420 the event identifier/generator fails to identify such a network pattern, then the event identifier/generator identifies what the effects of the event stream indicating a sufficient deviation has on other components in the data processing system (step 426). If the event stream indicating a sufficient deviation causes other events sufficient deviations, then the event identifier/generator may generate a new network pattern of events (step 428) and store the network pattern (step 430). Optionally, the event identifier/generator updates the network signatures based on the monitored data (step 432), with the operation returning to step 410 thereafter.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perfoini the specified functions or acts, or combinations of special purpose hardware and computer instructions.

Thus, the illustrative embodiments consider relationships between various system parameters and create a two layer network where a lower layer or physical network represents physical and logical entities and their relationship and a higher layer of information network represents parameters and their known relationship. The relationships in the information network are derived from the underlying physical network as well as known correlations between different parameters. The relationships in the information network are used to trigger the model updates, such that an update of one parameter model triggers updates of other models parameters which are related to the triggering parameter by a certain relationship. In this way, portions of the network that are potentially more dynamic are updated more frequently than those that are relatively stable.

Therefore, the illustrative embodiments provide a network-centric mechanism for updating models leading to better predictive capabilities and less false alarms. The mechanism of the illustrative embodiments trigger an update of the models in a cascading manner where an update of one parameter model may trigger updates of other model parameters that are related to each other by a “network pattern.” The mechanism “learns” of and identifies these network patterns and how the network patterns may be used to schedule model updates.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or ItO devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for updating network models in order to mitigate network issues, the method comprising:
for each component in a plurality of components in the data processing system, determining, by a network-centric modeling mechanism in the data processing system, whether a system parameter in a set of parameters particular to the component has deviated from a predicted system parameter value in a set of predicted system parameter values past a predetermined threshold;
responsive to the system parameter deviating from the predicted system parameter value past the predetermined threshold, generating, by the network-centric modeling mechanism, an event stream indicating a sufficient deviation;
determining, by the network-centric modeling mechanism, whether the event stream matches a previous pattern in a plurality of stored patterns; and
responsive to identifying the previous pattern that matches the event stream, preemptively mitigating, by the network-centric modeling mechanism, any related issues in the component or in a related component in the plurality of components using topology-aware indices associated with the previous pattern.

2. The method of claim 1, wherein preemptively mitigating any related issues in the component or in the related component in the plurality of components further comprises:
using, by the network-centric modeling mechanism, a set of network signatures to predict changes in one or more system parameter in the component or in the related component, responsive to the system parameter deviating from the predicted system parameter value past the predetermined threshold.

3. The method of claim 1, further comprising:
responsive to failing to identify the previous pattern that matches the event stream, identifying, by the network-centric modeling mechanism, one or more effects of the event stream on the component or on other components in the plurality of components; and
responsive to the event stream causing other sufficient deviations to the component or to other components in the plurality of components, generating, by the network-centric modeling mechanism, a new network pattern of events.

4. The method of claim 3, further comprising:
responsive to the event stream causing other sufficient deviations to the component or to other components in the plurality of components, updating, by the network-centric modeling mechanism, a set of network signatures in order to capture inter-dependencies of system parameters across the plurality of components.

5. The method of claim 1, further comprising:
performing, by the network-centric modeling mechanism, a discovery of each component in the plurality of components, wherein the plurality of components are either indirectly or directly coupled to the network-centric modeling mechanism;
generating, by the network-centric modeling mechanism, a physical network topology of the plurality of components;
generating, by the network-centric modeling mechanism, an information network topology by superimposing a set of network relationships on to the physical network topology; and
generating, by the network-centric modeling mechanism, topology-aware indices for each component in the set of components.

6. The method of claim 5, wherein superimposing the set of network relationships on to the physical network topology generates the information network topology that indicates how each component in the plurality of components performs with relation to other components in the plurality of components.

7. The method of claim 5, wherein the set of network relationships comprise at least one of self-containment relationships, neighbor relationships, tunnel relationships, downstream relationships, or upstream relationships.

8. The method of claim 5, wherein the set of network relationships are either specified by at least one of a network administrator or a system user or automatically extracted from at least one of service level agreements, policies, or rules.

9. A computer program product comprising a computer readable storage medium having a computer readable program stored therein, wherein the computer readable program, when executed on a computing device, causes the computing device to:
for each component in a plurality of components in a data processing system, determine whether a system parameter in a set of parameters particular to the component has deviated from a predicted system parameter value in a set of predicted system parameter values past a predetermined threshold;
responsive to the system parameter deviating from the predicted system parameter value past the predetermined threshold, generate an event stream indicating a sufficient deviation;
determine whether the event stream matches a previous pattern in a plurality of stored patterns; and
responsive to identifying the previous pattern that matches the event stream, preemptively mitigating any related issues in the component or in a related component in the plurality of components using topology-aware indices associated with the previous pattern.

10. The computer program product of claim 9, wherein the computer readable program to preemptively mitigating any related issues in the component or in the related component in the plurality of components further causes the computing device to:
use a set of network signatures to predict changes in one or more system parameter in the component or in the related component, responsive to the system parameter deviating from the predicted system parameter value past the predetermined threshold.

11. The computer program product of claim 9, wherein the computer readable program further causes the computing device to:
responsive to failing to identify the previous pattern that matches the event stream, identify one or more effects of the event stream on the component or on other components in the plurality of components; and
responsive to the event stream causing other sufficient deviations to the component or to other components in the plurality of components, generate a new network pattern of events.

12. The computer program product of claim 11, wherein the computer readable program further causes the computing device to:
responsive to the event stream causing other sufficient deviations to the component or to other components in the plurality of components, update a set of network signatures in order to capture inter-dependencies of system parameters across the plurality of components.

13. The computer program product of claim 9, wherein the computer readable program further causes the computing device to:
perform a discovery of each component in the plurality of components, wherein the plurality of components are either indirectly or directly coupled to the network-centric modeling mechanism;
generate a physical network topology of the plurality of components;
generate an information network topology by superimposing a set of network relationships on to the physical network topology; and
generate topology-aware indices for each component in the set of components.

14. The computer program product of claim 13, wherein superimposing the set of network relationships on to the physical network topology generates the information network topology that indicates how each component in the plurality of components performs with relation to other components in the plurality of components.

15. The computer program product of claim 13, wherein the set of network relationships comprise at least one of self-containment relationships, neighbor relationships, tunnel relationships, downstream relationships, or upstream relationships.

16. The computer program product of claim 13, wherein the set of network relationships are either specified by at least one of a network administrator or a system user or automatically extracted from at least one of service level agreements, policies, or rules.

17. An apparatus, comprising:
a processor; and
a memory coupled to the processor, wherein the memory comprises instructions which, when executed by the processor, cause the processor to:
for each component in a plurality of components in a data processing system, determine whether a system parameter in a set of parameters particular to the component has deviated from a predicted system parameter value in a set of predicted system parameter values past a predetermined threshold;
responsive to the system parameter deviating from the predicted system parameter value past the predetermined threshold, generate an event stream indicating a sufficient deviation;
determine whether the event stream matches a previous pattern in a plurality of stored patterns; and
responsive to identifying the previous pattern that matches the event stream, preemptively mitigating any related issues in the component or in a related component in the plurality of components using topology-aware indices associated with the previous pattern.

18. The apparatus of claim 17, wherein the instructions to preemptively mitigating any related issues in the component or in the related component in the plurality of components further cause the processor to:
use a set of network signatures to predict changes in one or more system parameter in the component or in the related component, responsive to the system parameter deviating from the predicted system parameter value past the predetermined threshold.

19. The apparatus of claim 17, wherein the instructions further cause the processor to:
responsive to failing to identify the previous pattern that matches the event stream, identify one or more effects of the event stream on the component or on other components in the plurality of components; and
responsive to the event stream causing other sufficient deviations to the component or to other components in the plurality of components, generate a new network pattern of events.

20. The apparatus of claim 19, wherein the instructions further cause the processor to:
responsive to the event stream causing other sufficient deviations to the component or to other components in the plurality of components, update a set of network signatures in order to capture inter-dependencies of system parameters across the plurality of components.

21. The apparatus of claim 17, wherein the instructions further cause the processor to:
perform a discovery of each component in the plurality of components, wherein the plurality of components are either indirectly or directly coupled to the network-centric modeling mechanism;
generate a physical network topology of the plurality of components;
generate an information network topology by superimposing a set of network relationships on to the physical network topology; and
generate topology-aware indices for each component in the set of components.

22. The apparatus of claim 21, wherein superimposing the set of network relationships on to the physical network topology generates the information network topology that indicates how each component in the plurality of components performs with relation to other components in the plurality of components.

23. The apparatus of claim 21, wherein the set of network relationships comprise at least one of self-containment relationships, neighbor relationships, tunnel relationships, downstream relationships, or upstream relationships.

24. The apparatus of claim 21, wherein the set of network relationships are either specified by at least one of a network administrator or a system user or automatically extracted from at least one of service level agreements, policies, or rules.
